(19) United States
(12) Patent Application Publication
(10) Pub. No.: US 2026/0266433 A1
(43) Pub. Date: Sep. 10, 2026

(54) LIGHT EMITTING DEVICE

(71) Applicant: SIGNIFY HOLDING B.V., EINDHOVEN (NL)

(72) Inventors: TIES VAN BOMMEL, HORST (NL); RIFAT ATA MUSTAFA HIKMET, EINDHOVEN (NL)

(21) Appl. No.: 19/162,439

(22) PCT Filed: Feb. 20, 2024
(86) PCT No.: PCT/EP2024/054282

§ 371 Date: Sep. 5, 2025

(30) Foreign Application Priority Data
Mar. 7, 2023 (EP) 23160472.9

(51) Int. Cl. F21K 9/232; F21K 9/64; F21Y 103/10; F21Y 113/17; H05B 45/20; H05B 47/19

(52) U.S. Cl. CPC F21K 9/232; F21K 9/64; H05B 45/20; H05B 47/19; F21Y 2103/10; F21Y 2113/17

(57) ABSTRACT

A light emitting diode, LED, filament lamp (100) comprises a first LED filament (11) comprising a first plurality of LEDs, (101) on a first elongated carrier (102) and electrically connected in a first circuit (103) and configured to emit first blue LED light, a second LED filament (12) comprising a second plurality of LEDs (111) on a second elongated carrier (112) and electrically connected in a second circuit (113) and configured to emit second blue LED light. The second LED filament (12) comprises a third plurality of LEDs (121) electrically connected in a third circuit (123) and configured to emit red LED light. Luminescent material covers the second elongated carrier (112), the second and third plurality of LEDs (111, 121), configured to convert the second blue LED light into green converted light. A control unit (140) separately controls emission of LED light from the plurality of LEDs (101, 111, 121).

### FIELD OF THE INVENTION

The present invention generally relates to light emitting devices. More specifically, the present invention is related to a light emitting diode (LED) filament lamp comprising a plurality of elongated carriers, each elongated carrier comprising a plurality of LEDs.

### BACKGROUND OF THE INVENTION

The original bulb lamps powered by electricity were of the type having metal wire filaments enclosed within more or less evacuated glass bulbs. This type of bulb lamps was the ubiquitous choice of light source for more than a century until the introduction of LEDs. Light sources based on LEDs have now replaced the light bulb as a source of light in homes and in many other locations. Initially, mainly due to the inherent structural characteristics of LEDs, the early LED light sources (i.e. LED lamps) did not resemble the earlier light bulbs and in many cases were considered as aesthetically inferior to a light bulb of the earlier type. Thus, for aesthetic reasons, a desire for light sources having the look of the traditional bulb shaped filament lamp came back when it was found that this was technically feasible to make light sources using LED filaments.

In present day LED filament light sources many small LEDs are mounted closely together on a wire or thin strip. Such wires or strips may be configured with LEDs that emit light of different colors, some of which may be embedded in luminescent material configured to convert light emitted at a first color into another color. Thereby it is possible to control the output of light such that, to a large extent, the output from the light source looks similar to the early metal wire filament light bulbs, and also possible to control the output of light such that it obtains any desired color. However, a drawback with such LED filament light sources is that they are unable to provide only blue light.

WO 2021/073930 discloses a LED filament lamp, comprising at least one LED filament having a base portion and a top portion extending over a length, L, along a longitudinal axis, A, wherein the LED filament comprises an array of a plurality of LEDs, extending along the longitudinal axis A. An encapsulant at least partially enclosing the plurality of LEDs, wherein the encapsulant comprises a luminescent material. The linear array of LEDs comprising a plurality N of blue LEDs emitting blue light and a plurality of M red LEDs emitting red light, the linear array of LEDs comprising a density of blue LEDs and a density of red LEDs, The density of blue LEDs decreases and/or the density of red LEDs increases from the base portion to the top portion along at least a portion of the length (L), whereby the color temperature of the light emitted from the at least one LED filament decreases from the base portion to the top portion over at least a portion of the length of the at least one LED filament.

### SUMMARY OF THE INVENTION

It is of interest to provide a LED filament light source that is capable of providing light of any desired color including only blue light.

This and other objects are achieved in a first aspect by providing a LED filament lamp having the features of the appended independent claim. Preferred embodiments are defined in the appended dependent claims.

Hence, according to the present invention, there is provided a LED filament lamp providing LED filament lamp light. The LED filament lamp comprises a first LED filament comprising a first plurality of LEDs arranged on a first elongated carrier. The first plurality of LEDs are electrically connected in a first circuit and configured to emit first blue LED light.

The LED filament lamp comprises a second LED filament comprising a second plurality of LEDs arranged on a second elongated carrier. The second plurality of LEDs are electrically connected in a second circuit and configured to emit second blue LED light. For example, the second blue LED light may have a second peak wavelength while the first blue LED light may have a first peak wavelength and the absolute value of the difference between these peak wavelengths may be greater than or equal to 20 nm.

The second LED filament comprises a third plurality of LEDs arranged on the second elongated carrier. The third plurality of LEDs are electrically connected in a third circuit and configured to emit red LED light.

The second LED filament comprises a first elongated encapsulant configured to at least partly cover the second elongated carrier, the second plurality of LEDs and the third plurality of LEDs. The first elongated encapsulant comprises a first luminescent material configured to convert second blue LED light emitted by the second plurality of LEDs into green converted light. For example, the first luminescent material of the first elongated encapsulant may be configured to fully convert second blue LED light emitted by the second plurality of LEDs into green converted light.

A control unit is connected to the first, second and third circuits and the control unit is configured to separately control emission of first blue LED light from the first plurality of LEDs, configured to separately control emission of second blue LED light from the second plurality of LEDs and configured to separately control emission of red LED light from the third plurality of LEDs.

That is, such a LED filament lamp comprises a first LED filament that emits blue light together with a second LED filament that emits non-blue light. Such a configuration enables an effect of providing output of light of any desired color, including only blue light, due to the configuration of the LED filament lamp such that the first LED filament is separated from the second LED filament. That is, the first plurality of LEDs are not arranged on the same elongated carrier as the second and third pluralities of LEDs. A reason for this effect of output of light of any desired color, including only blue light is that the first elongated encapsulant that comprises a first luminescent material is not excited by the light emitted by the blue LED filament light emitted from the first LED filament. Moreover, by configuring the first and second plurality of LEDs to emit, respectively, blue LED light having a first peak wavelength and a second peak wavelength, where the second peak wavelength is optimized for a maximum excitation coefficient of the first luminescent material and where the first peak wavelength differs by at least 20 nm from the second peak wavelength, cross-excitation (i.e. cross-talk) of the first luminescent material by the first blue LED light can be avoided or at least minimized (to a very low degree).

Furthermore, by configuring the first luminescent material of the first elongated encapsulant to fully convert second blue LED light emitted by the second plurality of LEDs into green converted light means that at least 97% of the second blue LED light is converted into green light by the first luminescent material.

The control unit may be configured to, in a first operational mode, power only the first plurality of LEDs such that the LED filament lamp light is blue light. The control unit may be configured to, in a second operational mode, power only the second plurality of LEDs such that the LED filament lamp light is green light. The control unit may be configured to, in a third operational mode, power only the third plurality of LEDs such that the LED filament lamp light is red light. The control unit may be configured to, in a fourth operational mode, power the first plurality of LEDs, the second plurality of LEDs and the third plurality of LEDs such that the LED filament lamp is set to emit white LED filament lamp light having a first correlated color temperature, CCT1, in a range from 1500K to 6500K and a first color rendering index, CRI, of at least 80.

In other words, the configuration of the control unit may be such that, in the first operational mode, the LED filament lamp emits light with only a blue (B) intensity, in the second operational mode, the LED filament lamp emits light with only a green (G) intensity and, in the third operational mode, the LED filament lamp emits light with only a red (R) intensity. In the fourth operational mode, the LED filament lamp emits white light with a B-intensity, a G-intensity and an R-intensity.

Moreover, the control unit may be configured to, in a fifth operational mode, power the first plurality of LEDs, the second plurality of LEDs and the third plurality of LEDs differently as in the fourth operational mode such that the LED filament lamp is set to emit white LED filament lamp light having a second correlated color temperature, CCT2, in a range from 1500K to 6500K and a second CRI of at least 80, wherein CCT2-CCT1≥500K.

In other words, the configuration of the control unit may be such that, in the fifth operational mode, the LED filament lamp emits white light where a B-intensity, a G-intensity and an R-intensity are different than in the fourth operational mode. For example, the intensity ratio B/(R+G) may be higher in the fifth operational than the intensity ratio B/(R+G) in the fourth operational mode.

The first LED filament and the second LED filament may be arranged in relation to each other such that a mutual distance, D, between the first LED filament and the second LED filament is at least 15 mm, preferably at least 20 mm, and, optionally, D may be less than 60 mm.

By arranging the first LED filament and the second LED filament separated from each other by such a distance it is possible to further ensure that the first luminescent material of the first elongated encapsulant is not excited by the light emitted by the blue LED filament light emitted from the first LED filament. It is thereby ensured that the LED filament lamp is capable of emitting light of any color including white light as well as pure blue light. It is to be noted that the minimum mutual distance of 15 mm is to be interpreted as the minimum mutual distance for all points along the first and second LED filaments. Furthermore, by arranging the first LED filament and the second LED filament separated from each other by such a distance, it is possible to obtain an optimal viewing experience in that the first LED filament and the second LED filament are not perceived as multiple separate light sources by a viewer. D may be less than 60 mm, then it is possible to obtain an optimal viewing experience in that the first LED filament and the second LED filament are not perceived as multiple separate light sources by a viewer of the LED filament lamp.

The first LED filament may be obliquely arranged with respect to the second LED filament where the axis of elongation of the first LED filament and the axis of elongation of the second LED filament are not arranged in a plane.

By arranging the LED filaments obliquely, it is possible to further ensure that the first luminescent material of the first elongated encapsulant is not excited by the light emitted by the blue LED filament light emitted from the first LED filament, and thereby ensuring that the LED filament lamp is capable of emitting light of any color including white light as well as pure blue light.

A second elongated encapsulant may at least partly be covering the first elongated carrier and the first plurality of LEDs. The second elongated encapsulant may comprising a light scattering material configured to scatter the first blue LED light into blue scattered light. An obtained effect is improved aesthetics and/or spatial light distribution. In such a case, the first elongated carrier may be light transmissive and the first plurality of LEDs arranged on a first major surface of the first elongated carrier and a further second encapsulant may at least partly cover a second major surface, opposite to the first major surface. Such a further second encapsulant may comprise a light scattering material configured to scatter the first blue LED light and/or blue scattered light into further blue scattered light. An obtained effect is further improved aesthetics and/or spatial light distribution.

The second plurality of LEDs and the third plurality of LEDs may be arranged on the same surface of the second elongated carrier. Alternatively, the second plurality of LEDs and the third plurality of LEDs may be arranged on a respective surface of the second elongated carrier, for example on opposite sides of the second elongated carrier.

The second elongated carrier may be light transmissive and the second and third plurality of LEDs arranged on a first major surface of the second elongated carrier. In such a configuration, a further first encapsulant is at least partly covering a second major surface of the second elongated carrier, opposite to the first major surface of the second elongated carrier and this further first encapsulant comprises a further luminescent material configured to convert the second blue LED light and/or green converted light into further green converted light.

The first LED filament and the second LED filament may be spiral shaped. Moreover, the LED filament lamp may comprise N first LED filaments and M second LED filaments, wherein M is greater than N.

The LED filament lamp may comprise an envelope configured to at least partly enclose the first and second LED filaments and a connector for electrically and mechanically connecting the LED filament lamp to a socket of a luminaire. An antenna may be functionally coupled to the control unit and the control unit configured to be controlled by a remote user interface via the antenna to separately control emission of first blue LED light from said first plurality of LEDs, configured to separately control emission of second blue LED light from said second plurality of LEDs and configured to separately control emission of red LED light from said third plurality of LEDs.

### BRIEF DESCRIPTION OF THE DRAWINGS

This and other aspects of the present invention will now be described in more detail, with reference to the appended drawings showing embodiment(s) of the invention.

FIG. 1a schematically illustrates a LED filament lamp arranged in a luminaire,

FIG. 1b schematically illustrates an embodiment of a first LED filament,

FIG. 1c schematically illustrates an embodiment of a first LED filament,

FIG. 1d schematically illustrates an embodiment of a second LED filament,

FIG. 2 schematically illustrates an embodiment of a LED filament lamp having obliquely configured first and second LED filaments,

FIG. 3 schematically illustrates an embodiment of a LED filament lamp having first and second LED filaments are spiral shaped,

FIG. 4 schematically illustrates an embodiment of a LED filament lamp having obliquely configured first and second LED filaments, and

FIG. 5 schematically illustrates an embodiment of a LED filament lamp having first and second LED filaments are spiral shaped.

### DETAILED DESCRIPTION

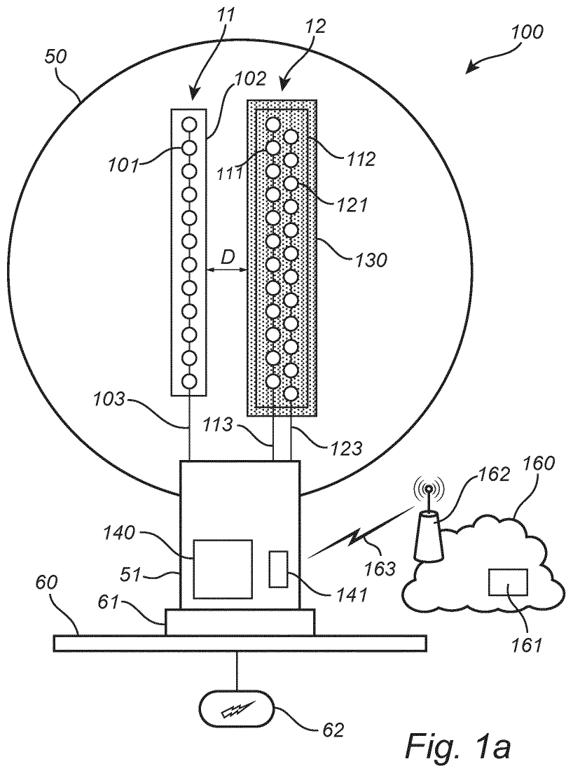

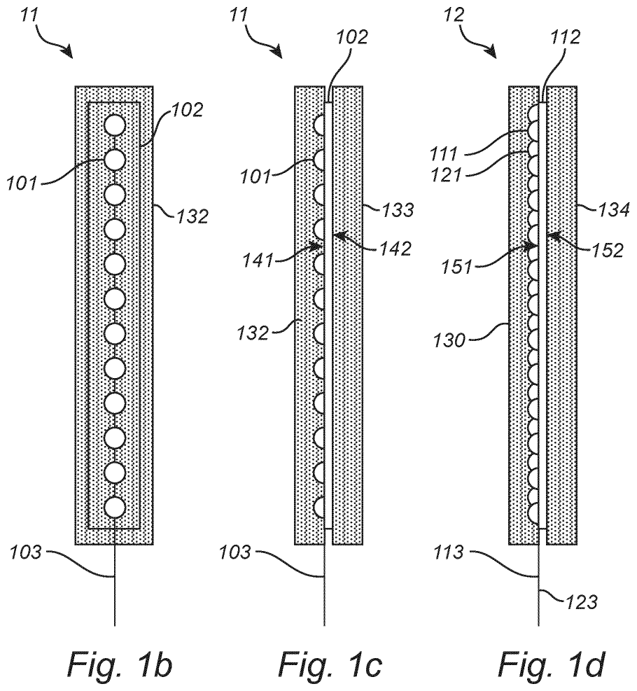

As illustrated in FIG. 1a, an embodiment of a LED filament lamp 100 that is configured to provide LED filament lamp light comprises a first LED filament 11 comprising a first plurality of LEDs 101. The first plurality of LEDs 101 are arranged on a first elongated carrier 102 and the first plurality of LEDs 101 are electrically connected in a first circuit 103 and configured to emit first blue LED light, for example blue light having a (dominant) peak wavelength in the wavelength interval 430-470 nm. A second LED filament 12 comprises a second plurality of LEDs 111 arranged on a second elongated carrier 112. The second plurality of LEDs 111 are electrically connected in a second circuit 113 and configured to emit second blue LED light, for example blue light having a (dominant) peak wavelength in the wavelength interval 430-470 nm. In at least one embodiment, the second blue LED light may have a second peak wavelength while the first blue LED light may have a first peak wavelength and the absolute value of the difference between these peak wavelengths is greater than or equal to 20 nm.

The second LED filament 12 further comprises a third plurality of LEDs 121 arranged on the second elongated carrier 112. The third plurality of LEDs 121 are electrically connected in a third circuit 123 and configured to emit red LED light, for example red light having a (dominant) peak wavelength in any of the wavelength intervals 610-660 nm and 620-635 nm.

The second LED filament 12 further comprises a first elongated encapsulant 130 configured to at least partly cover the second elongated carrier 112, the second plurality of LEDs 111 and the third plurality of LEDs 121. The first elongated encapsulant 130 comprises a first luminescent material configured to convert second blue LED light emitted by the second plurality of LEDs 111 into green converted light, for example green light having a (dominant) peak wavelength in a wavelength interval 495-570 nm, e.g. 525-565 nm and 510-520 nm. For example, the first luminescent material of the first elongated encapsulant may be configured to fully, i.e. at least 97%, convert second blue LED light emitted by the second plurality of LEDs into green converted light. It is to be noted that the conversion rate depends on the particle size of the luminescent material, the thickness of the luminescent material and the concentration of the particles in the luminescent material. Examples of the first luminescent material include quantum dots e.g. having a (dominant) peak wavelength at 530 nm and Lu₃Al₅O₁₂:Ce³⁺ (LuAG) e.g. having a (dominant) peak wavelength at 525 nm.

A control unit 140 is connected to the first, second and third circuits 103, 113, 123 and the control unit 140 is configured to separately control emission of first blue LED light from the first plurality of LEDs 101, configured to separately control emission of second blue LED light from the second plurality of LEDs 111 and configured to separately control emission of red LED light from the third plurality of LEDs 121.

The control unit 140 is in various embodiments of the LED filament lamp 100 configured to operate in several operational modes in which power is controlled to the various pluralities of LEDs 101, 111, 121.

For example, in at least one embodiment, the control unit 140 is configured to, in a first operational mode, power only the first plurality of LEDs 101 such that the LED filament lamp light is blue light, in a second operational mode, power only the second plurality of LEDs 111 such that the LED filament lamp light is green light, in a third operational mode, power only the third plurality of LEDs 121 such that the LED filament lamp light is red light, and, in a fourth operational mode, power the first plurality of LEDs 101, the second plurality of LEDs 111 and the third plurality of LEDs 121 such that the LED filament lamp is set to emit white LED filament lamp light having a first correlated color temperature, CCT1, in a range from 1500K to 6500K and a first color rendering index, CRI, of at least 80. For example, in the fourth operational mode, the LED filament lamp emits white light having a respective fourth mode B-intensity, G-intensity and R-intensity.

In at least one embodiment, the control unit 140 is configured to, in a fifth operational mode, power the first plurality of LEDs 101, the second plurality of LEDs 111 and the third plurality of LEDs 121 differently as in the fourth operational mode such that the LED filament lamp is set to emit white LED filament lamp light having a second correlated color temperature, CCT2, in a range from 1500K to 6500K and a second CRI of at least 80, wherein CCT2−CCT1≥500K. For example, in the fifth operational mode, the LED filament lamp emits white light having a respective fifth mode B-intensity, G-intensity and R-intensity. Here, a ratio B/(R+G) of the fifth mode intensities is higher than a ratio B/(R+G) of the fourth mode intensities.

FIG. 1a further illustrates that the first LED filament 11 and the second LED filament 12 are arranged in relation to each other with a mutual distance D between the first LED filament 11 and the second LED filament 12. By arranging the first LED filament 11 and the second LED filament 12 such that D is at least 15 mm, preferably at least 20 mm, cross-excitation (i.e. cross-talk) of the first luminescent material of the first elongated encapsulant by the light emitted by the blue LED filament light emitted from the first LED filament 11 can be avoided or at least minimized (to a very low degree) and thereby enabling output of pure blue light from the LED filament lamp 100, i.e. the blue light emitted by the first LED filament 11. Furthermore, by arranging the first LED filament 11 and the second LED filament 12 such that their mutual distance is less than 60 mm, then it is possible to obtain an optimal viewing experience in that the first LED filament 101 and the second LED filament 111 are not perceived as multiple separate light sources by a viewer of the LED filament lamp 100.

As illustrated in FIG. 1b, in at least one embodiment, a second elongated encapsulant 132 may at least partly cover the first elongated carrier 102 and the first plurality of LEDs 101. In such a case, the second elongated encapsulant 132 may comprise a light scattering material configured to scatter the first blue LED light into blue scattered light, for example a blue phosphor material that comprises europium-doped barium orthosilicate (BOSE).

As illustrated in FIG. 1c, in at least one embodiment, the first elongated carrier 102 is light transmissive and the first plurality of LEDs 101 are arranged on a first major surface 141 of the first elongated carrier 102. A further second encapsulant 133 is at least partly covering a second major surface 142 of the first elongated carrier 102, opposite to the first major surface 141. In such a case, the further second encapsulant 133 may comprise a light scattering material configured to scatter the first blue LED light and/or blue scattered light into further blue scattered light.

As illustrated in FIG. 1a and in FIG. 1d, the second plurality of LEDs 111 and the third plurality of LEDs 121 may be arranged on the same surface of the second elongated carrier 112. However, in at least one alternative embodiment, the second plurality of LEDs 111 and the third plurality of LEDs 121 may be arranged on different surfaces of the second elongated carrier 112, for example on opposite sides of the second elongated carrier 112.

Moreover, as further illustrated in FIG. 1d, in at least one embodiment, the second elongated carrier 112 is light transmissive and wherein the second and third plurality of LEDs 111, 121 are arranged on a first major surface 151 of the second elongated carrier 112 and wherein a further first encapsulant 134 is at least partly covering a second major surface 152 of the second elongated carrier 112, opposite to said first major surface 151 of the second elongated carrier 112, said further first encapsulant 134 comprising a further luminescent material configured to convert the second blue LED light and/or green converted light into further green converted light.

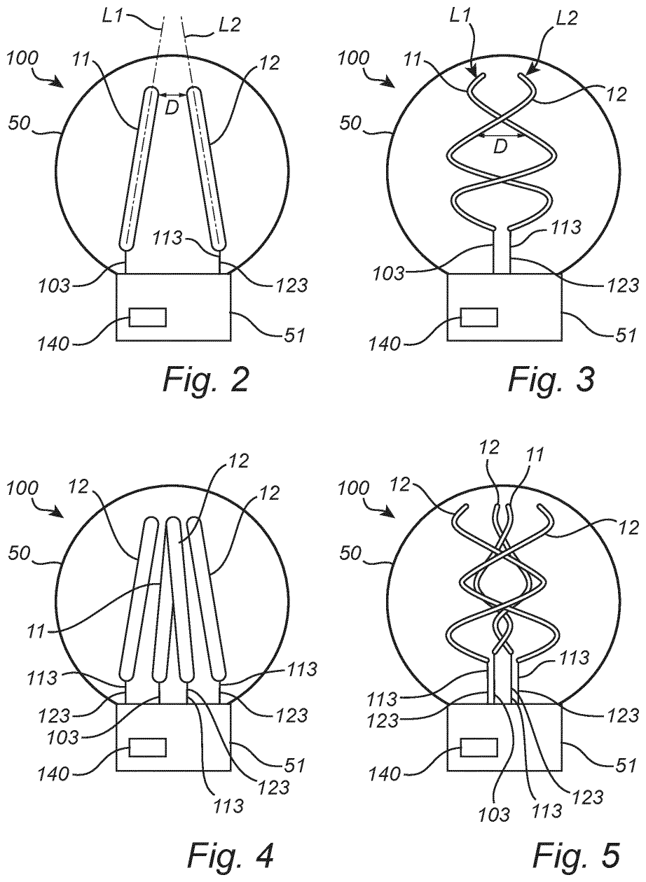

As illustrated in FIG. 2, in at least one embodiment, the first LED filament 11 may be obliquely arranged with respect to the second LED filament 12. The axis of elongation L1 of the first LED filament 11 and the axis of elongation L2 of the second LED filament 12 are not arranged in a plane. As indicated, the first LED filament 11 and the second LED filament 12 are arranged in relation to each other with a mutual distance D between the first LED filament 11 and the second LED filament 12. Due to the oblique arrangement of the LED filaments 11, 12, it is pointed out that the mutual distance D defines the minimum mutual distance at any point along each of the LED filaments 11, 12.

As illustrated in FIG. 3, in at least one embodiment, the first LED filament 11 and the second LED filament 12 are spiral shaped. Also here, as indicated, the first LED filament 11 and the second LED filament 12 are arranged in relation to each other with a mutual distance D between the first LED filament 11 and the second LED filament 12. Due to the spiral arrangement of the LED filaments 11, 12, it is pointed out that the mutual distance D defines the minimum mutual distance at any point along each of the LED filaments 11, 12.

As illustrated in FIGS. 4 and 5, in various embodiments, the LED filament lamp 100 may comprise a plurality of first and second LED filaments 11, 12. For example, LED filament lamp 100 may comprise N first LED filaments 11 and M second LED filaments 12, wherein M>N. In FIGS. 4 and 5, N=1 and M=3. As for the embodiments described above, the first LED filament 11 and the second LED filaments 12 are arranged in relation to each other with a mutual distance D between the first LED filament 11 and the second LED filaments 12. Due to the oblique and spiral arrangements of the LED filaments 11, 12 in FIG. 4 and FIG. 5, respectively, it is pointed out that the mutual distance D defines the minimum mutual distance at any point along each of the LED filaments 11, 12.

Returning now to FIG. 1a, in at least one embodiment, the LED filament lamp 100 may comprise an envelope 50 configured to at least partly enclose the first and second LED filaments 11, 12, a connector 51 for electrically and mechanically connecting the LED filament lamp 100 to a socket 61 of a luminaire 60. Further, an antenna 141 may be functionally coupled to the control unit 140, wherein the control unit 140 is configured to be controlled by a remote user interface 161 via the antenna 141 to separately control emission of first blue LED light from the first plurality of LEDs 101, configured to separately control emission of second blue LED light from the second plurality of LEDs 111 and configured to separately control emission of red LED light from the third plurality of LEDs 121. An electric power source 62 may be connected to the luminaire 60 and thereby, via the socket 61 provide necessary electric power to the LED filament lamp 100. As schematically illustrated in FIG. 1a, a connection between the remote user interface 161 and the control unit 140 may be realized by standardized communication means including an internet protocol based network 160 that comprises a wireless access point 162 that provides a wireless communication interface 163 via which communication may take place between the user interface 161 and the control unit 140.

The person skilled in the art realizes that the present invention by no means is limited to the embodiments described above. On the contrary, many modifications and variations are possible within the scope of the appended claims. For example, the LED filaments 11, 12 may have different shapes, dimensions and/or sizes than those depicted/described.

1. A light emitting diode, LED, filament lamp providing LED filament lamp light and comprising:
a first LED filament comprising a first plurality of light emitting diodes, LEDs, arranged on a first elongated carrier, said first plurality of LEDs being electrically connected in a first circuit and configured to emit first blue LED light;
a second LED filament comprising a second plurality of LEDs arranged on a second elongated carrier, said second plurality of LEDs being electrically connected in a second circuit and configured to emit second blue LED light;
said second LED filament further comprising a third plurality of LEDs arranged on the second elongated carrier, said third plurality of LEDs being electrically connected in a third circuit and configured to emit red LED light;
said second LED filament further comprising a first elongated encapsulant configured to at least partly cover the second elongated carrier, the second plurality of LEDs and the third plurality of LEDs, said first elongated encapsulant comprising a first luminescent material configured to convert second blue LED light emitted by the second plurality of LEDs into green converted light,
a control unit connected to said first, second and third circuits and wherein said control unit is configured to separately control emission of first blue LED light from said first plurality of LEDs, configured to separately control emission of second blue LED light from said second plurality of LEDs and configured to separately control emission of red LED light from said third plurality of LEDs,
wherein the control unit is configured to:
in a first operational mode, power only the first plurality of LEDs such that the LED filament lamp light is blue light;
in a second operational mode, power only the second plurality of LEDs such that the LED filament lamp light is green light;
in a third operational mode, power only the third plurality of LEDs such that the LED filament lamp light is red light; and
in a fourth operational mode, power the first plurality of LEDs, the second plurality of LEDs and the third plurality of LEDs such that the LED filament lamp is set to emit white LED filament lamp light having a first correlated color temperature, CCT1, in a range from 1500K to 6500K and a first color rendering index, CRI, of at least 80.

2. The LED filament lamp of claim 1, wherein the control unit is configured to:
in a fifth operational mode, power the first plurality of LEDs, the second plurality of LEDs and the third plurality of LEDs differently as in the fourth operational mode such that the LED filament lamp is set to emit white LED filament lamp light having a second correlated color temperature, CCT2, in a range from 1500K to 6500K and a second CRI of at least 80, wherein CCT2−CCT1≥500K.

3. The LED filament lamp according to claim 1, wherein the first luminescent material of said first elongated encapsulant is configured to fully convert second blue LED light emitted by the second plurality of LEDs into green converted light.

4. The LED filament lamp according to claim 1, wherein the first LED filament and the second LED filament are arranged in relation to each other such that a mutual distance, D, between the first LED filament and the second LED filament is at least 15 mm, preferably at least 20 mm.

5. The LED filament lamp according to claim 4, wherein D is less than 60 mm.

6. The LED filament lamp according to claim 1, wherein the first LED filament is obliquely arranged with respect to the second LED filament, and wherein the axis of elongation of the first LED filament and the axis of elongation of the second LED filament are not arranged in a plane.

7. The LED filament lamp according to claim 1, wherein a second elongated encapsulant is at least partly covering the first elongated carrier and the first plurality of LEDs, said second elongated encapsulant comprising a light scattering material configured to scatter the first blue LED light into blue scattered light.

8. The LED filament lamp according to claim 7, wherein the first elongated carrier is light transmissive and wherein the first plurality of LEDs are arranged on a first major surface of the first elongated carrier and wherein a further second encapsulant is at least partly covering a second major surface, opposite to said first major surface, the further second encapsulant comprising a light scattering material configured to scatter the first blue LED light and/or blue scattered light into further blue scattered light.

9. The LED filament lamp according to claim 1, wherein the second plurality of LEDs and the third plurality of LEDs are arranged on the same surface of said second elongated carrier.

10. The LED filament lamp according to claim 1, wherein the second elongated carrier is light transmissive and wherein the second and third plurality of LEDs are arranged on a first major surface of the second elongated carrier and wherein a further first encapsulant is at least partly covering a second major surface of the second elongated carrier, opposite to said first major surface of the second elongated carrier, said further first encapsulant comprising a further luminescent material configured to convert the second blue LED light and/or green converted light into further green converted light.

11. The LED filament lamp according to claim 1, wherein the first LED filament and the second LED filament are spiral shaped.

12. The LED filament lamp according to claim 1, wherein the first blue LED light has a first peak wavelength (λ1) and the second blue LED light has a second peak wavelength (λ2), wherein |λ2−λ1|≥20 nm.

13. The LED filament lamp according to claim 1, comprising N first LED filaments and M second LED filaments, wherein M>N.

14. The LED filament lamp according to claim 1:
an envelope configured to at least partly enclose said first and second LED filaments;
a connector for electrically and mechanically connecting said LED filament lamp to a socket of a luminaire;
an antenna functionally coupled to the control unit, wherein the control unit is configured to be controlled by a remote user interface via the antenna to separately control emission of first blue LED light from said first plurality of LEDs, configured to separately control emission of second blue LED light from said second plurality of LEDs and configured to separately control emission of red LED light from said third plurality of LEDs.
